(19) United States
(12) Patent Application Publication
(10) Pub. No.: US 2026/0298355 A1
(43) Pub. Date: Oct. 1, 2026

(54) HIGH-TEMPERATURE DIAPHRAGM VALVE

(71) Applicant: KITZ SCT CORPORATION, Tokyo (JP)

(72) Inventors: Gihyeon SUNG, Ohta-shi, Gunma (JP); Katsuhiko HOMMA, Ohta-shi, Gunma (JP); Hajime HORIGUCHI, Ohta-shi, Gunma (JP)

(21) Appl. No.: 19/479,483

(22) PCT Filed: Mar. 1, 2024
(86) PCT No.: PCT/JP2024/007663

§ 371 Date: Oct. 28, 2025

(30) Foreign Application Priority Data
Apr. 28, 2023 (JP) 2023-074263

(51) Int. Cl. F16K 7/12; F16K 25/00; F16K 27/02

(52) U.S. Cl. CPC F16K 7/126; F16K 25/005; F16K 27/0236

(57) ABSTRACT

A high-temperature diaphragm valve capable of stably performing a valve opening/closing operation even under a high temperature environment and capable of preventing a sealing property from deteriorating. The high-temperature diaphragm valve (1) includes a holder (80) that is suspended by a diaphragm (33) that hermetically seals a valve chamber (12c) and moves to a valve opening/closing position in conjunction with a stem (30) with a seal member (81) to be brought into contact with a valve seat surface (12a) during valve closing held therein, and a pulling-up/aligning mechanism (50) that connects the stem (30) and the holder (80) to each other, in which the holder (80) is forcibly pulled up by the pulling-up/aligning mechanism (50) during valve opening, and the seal member (81) held in the holder by the pulling-up/aligning mechanism (50) seals the valve seat surface (12a) with a uniform force during valve closing.

### BACKGROUND OF THE INVENTION

### 1. Technical Field

The present invention relates to a high-temperature diaphragm valve, and particularly to a high-temperature diaphragm valve that moves a holder, which is suspended by a diaphragm that hermetically seals a valve chamber and holds a seal member to be brought into contact with a valve seat surface during valve closing, to a valve opening/closing position in conjunction with a stem.

### 2. Background Art

Conventionally, as an opening/closing valve used for a gas supply line system such as a semiconductor manufacturing apparatus, a solar cell manufacturing apparatus, or a liquid crystal manufacturing apparatus, it has been demanded that a dead space is small and generation of particles is suppressed. A diaphragm valve has been frequently used as a valve that meets the demand.

Examples of the diaphragm valve of this type include one in which a seal member that seals a valve seat is not provided on the body side but is provided on the side of a valve body operating in conjunction with up-down movement of a stem.

For example, Patent Literature 1 describes a diaphragm valve in which a holder that holds a conical seal member in a valve box and a diaphragm piece are coupled to each other, an outer peripheral edge of an inner diameter port of a diaphragm is attached between the holder and the diaphragm piece, the diaphragm piece is held movably up and down by a bonnet, and the holder is structured to be suspended by the diaphragm with the outer peripheral edge of the diaphragm attached between the holder and the bonnet.

Patent Literature 2 describes a diaphragm valve including a body having a fluid inlet passage, a fluid outlet passage, a valve chamber, and a valve seat formed therein, a bonnet nut screw-fitted to the body, a stem screwed into and supported on the bonnet nut movably up and down, a handle attached to an upper end of the stem, a holder attached to a lower end of the stem movably up and down, a deflection limiter provided in a lower portion of an upwardly protruding support shaft of the holder by being inserted into the support shaft, and a metal diaphragm having an outer peripheral edge attached by pressure and supported between the body and the bonnet nut and having an inner peripheral edge welded to the holder and the deflection limiter and in which the holder is structured to be suspended by the diaphragm.

Further, examples of the conventional diaphragm valve of this type include one illustrated in FIG. 8. In this diaphragm valve 200, air is supplied into a bellows 210 so that the bellows 210 expands, whereby a lower surface of a bellows flange 220, which has fallen, and a roller 231 on one end side of a cam part 230 contact each other. Accordingly, the one end side of the cam part 230 is inclined downward, and a stem 240 is raised by a roller 232 on the other end side inclined upward.

When the stem 240 thus rises, a diaphragm piece 270 and a holder 280 connected to the diaphragm piece 270 are lifted using an elastic restoring force of a diaphragm 250 and an elastic force of a lifting spring 260, so that the diaphragm valve 200 enters a valve opened state where a seal member 281 separates from a valve seat surface 290.

On the other hand, when the supply of air is stopped so that the bellows 210 shrinks, a retainer 242 is pushed down with an elastic force of a spring 241 and the stem 240 locked to the retainer 242 falls in the diaphragm valve 200.

Accordingly, a lower end of the stem 240 contacts an upper end of the diaphragm piece 270 so that a lowering force is exerted on the diaphragm piece 270.

Thus, the force for lowering the diaphragm piece 270 is exerted against a reaction force that is a combination of respective elastic forces of the diaphragm 250 and the lifting spring 260. Accordingly, the holder 280 connected to the diaphragm piece 270 falls, so that the diaphragm valve 200 enters a valve closed state where the seal member 281 contacts the valve seat surface 290.

As such a diaphragm valve, ones that can withstand use under a high temperature environment exceeding 300 degrees have been demanded with a recent increasing demand for a heat resistance.

### CITATION LIST

### Patent Literature

Patent Literature 1

Japanese Patent Laid-Open No. 2020-159406

Patent Literature 2

Japanese Patent Laid-Open No. 11-182708

### SUMMARY OF THE INVENTION

### 1. Technical Problem

However, when a diaphragm valve is used under a high temperature environment exceeding 300 degrees, an elastic restoring force of a diaphragm decreases due to an influence of a high temperature in the above-described conventional diaphragm valve. For the diaphragm valve illustrated in FIG. 8, an elastic force of a lifting spring also decreases in addition to that of a diaphragm. Therefore, even if a force for raising a holder during valve opening decreases and as a result a stem rises to move to a valve opening position, there occurs a valve closed state where a seal member contacts a valve seat surface, so that a valve opening/closing operation may be unstable.

In a conventional diaphragm valve, when a highly heat-resistant resin material or metal material that can be used under a use environment of 300 degrees or more is used as a seal member not to be dissolved by a high-temperature fluid, an elastic force decreases. When an alignment accuracy of the seal member with respect to a valve seat surface is low, a sealing property is greatly affected. Accordingly, an alignment accuracy of a holder needs to be enhanced.

However, in a conventional diaphragm valve having a structure in which a holder is suspended by a diaphragm, when rattling occurs between a diaphragm piece that moves up and down and a bonnet or between a stem and the bonnet nut, the holder is inclined during valve closing. When a seal member held in the inclined holder contacts a valve seat surface in an inclined state, a sealing property of the valve may deteriorate.

The present invention has been developed to solve the conventional problems, and has as its object to provide a high-temperature diaphragm valve capable of stably performing a valve opening/closing operation even under a high temperature environment and capable of preventing a sealing property from deteriorating.

### 2. Solution to the Problem

In order to attain the above-described object, an invention according to a first aspect provides a high-temperature diaphragm valve including a holder that is suspended by a diaphragm that hermetically seals a valve chamber and moves to a valve opening/closing position in conjunction with a stem with a seal member to be brought into contact with a valve seat surface during valve closing held therein, and a pulling-up/aligning mechanism that connects the stem and the holder to each other, in which the
pulling-up/aligning mechanism includes a diaphragm piece that sandwiches an inner peripheral edge of the diaphragm, an outer peripheral edge of which is held in a body, between the diaphragm piece and the holder, and a connection member that is arranged in a loosely fitted state between a lower end recess provided in the stem and an upper end recess provided in the diaphragm piece and to connect the stem and the diaphragm piece to each other and contacts both respective bottom surfaces of the lower end recess and the upper end recess to transmit an axial force of the stem to the diaphragm piece by downward movement of the stem for valve closing, the connection member has an elongated hole-shaped connection through hole, a width in an axial direction of the connection member of which is larger than a diameter of the connection pin, formed therein in a direction substantially perpendicular to the axial direction of the connection member and is connected to the diaphragm piece via the connection pin inserted into the connection diaphragm piece, and the holder is forcibly pulled up by the pulling-up/aligning mechanism during valve opening, and the seal member held in the holder by the pulling-up/aligning mechanism seals the valve seat surface with a uniform force during valve closing.

The invention according to a second aspect provides the high-temperature diaphragm valve, in which the connection member has arc-shaped curved surfaces respectively formed on its upper end surface and lower end surface, and the arc-shaped curved surfaces on the upper end surface and the lower end surface are respectively brought into contact with the bottom surfaces of the lower end recess and the upper end recess by downward movement of the stem for valve closing.

The invention according to a third aspect provides the high-temperature diaphragm valve, in which the connection member is connected to the stem via a locked step part locked to a locking step part provided in the lower end recess in the stem, and the locking step part in the stem is brought into contact with the locked step part in the connection member and an inner edge surface of a lower hole of the connection through hole is brought into contact with the connection pin by upward movement of the stem for valve opening.

The invention according to a fourth aspect provides the high-temperature diaphragm valve, in which a spacer is arranged on a bottom surface of the upper end recess of the diaphragm piece, and the arc-shaped curved surface on the lower end surface of the connection member is brought into contact with the spacer by downward movement of the stem for valve closing.

The invention according to a fifth aspect provides the high-temperature diaphragm valve, in which the seal member is composed of polyimide resin.

The invention according to a sixth aspect provides the high-temperature diaphragm valve, in which the seal member is annular, and the holder includes an annular housing part that houses the seal member, and further including a seal holding member that includes a cylindrical part having a cylindrical inner surface fitted into an inner peripheral surface of the annular housing part to hold the seal member at a position concentric with the holder, and an annular cushion member that is sandwiched between respective surfaces, on a bottom surface side of the annular housing part, of the seal holding member and the seal member and the bottom surface of the annular housing part and is held in the annular housing part at a position concentric with the holder with its inner peripheral surface fitted into the inner peripheral surface of the annular housing part, the seal member being held in the annular housing part with a gap formed between a surface facing the bottom surface of the annular housing part and the bottom surface of the annular housing part by expanding more radially outward than the annular cushion member.

The invention according to a seventh aspect provides the high-temperature diaphragm valve, in which the annular cushion member is composed of a material having a higher cushioning property than that of the seal member.

The invention according to an eighth aspect provides the high-temperature diaphragm valve, in which the seal holding member includes a flange part protruding in a flange shape radially outward at an end of the cylindrical part, and the seal member has a stepped contact surface, which is brought into contact with an outer peripheral surface of the cylindrical part including the flange part in a stepped shape, formed therein.

The invention according to a ninth aspect provides the high-temperature diaphragm valve, in which the seal member has a recess, in which the annular cushion member is arranged having a peripheral side surface slightly spaced apart from an outer peripheral surface of the annular cushion member, formed on its surface on the bottom surface side of the annular housing part, and the gap is formed between a surface of the seal member radially outside the recess and the bottom surface of the annular housing part.

The invention according to a tenth aspect provides the high-temperature diaphragm valve, in which the seal member is composed of polyimide resin, and the annular cushion member is composed of perfluoroalkoxyalkane resin.

### 3. Advantageous Effect of the Invention

According to the first aspect of the invention, the high-temperature diaphragm valve includes the pulling-up/aligning mechanism that connects the stem and the holder to each other.

Thus, even when an elastic restoring force of the diaphragm decreases by use under a high temperature environment, and even if the holder is susceptible to rattling due to being suspended by the diaphragm, the holder is forcibly pulled up by the pulling-up/aligning mechanism during valve opening, and the seal member held in the holder by the pulling-up/aligning mechanism seals the valve seat surface with a uniform force during valve closing.

This makes it possible to stably perform a valve opening/closing operation even under a high temperature environment and makes it possible to prevent a sealing property from deteriorating.

According to the invention, the pulling-up/aligning mechanism includes the diaphragm piece that sandwiches the inner peripheral edge of the diaphragm, the outer peripheral edge of which is held in the body, between the diaphragm piece and the holder, and the connection member that is arranged in a loosely fitted state between the lower end recess provided in the stem and the upper end recess provided in the diaphragm piece and to connect the stem and the diaphragm piece to each other and contacts both the respective bottom surfaces of the lower end recess and the upper end recess to transmit an axial force of the stem to the diaphragm piece by downward movement of the stem for valve closing.

Therefore, even when an elastic restoring force of the diaphragm decreases by use under a high temperature environment, the diaphragm piece connected to the stem via the connection member moves upward in conjunction with upward movement of the stem for valve opening, so that the holder connected to the diaphragm piece can be reliably moved upward to a valve opening position where the seal member separates from the valve seat surface.

During valve closing, even when rattling occurs, an axial force of the stem by downward movement of the stem via the connection member is transmitted to the holder through the bottom surface of the upper end recess in the diaphragm piece, so that the holder is aligned. Accordingly, the seal member contacts the valve seat surface in an aligned state.

This makes it possible to also stably perform a valve opening/closing operation under a high temperature environment, and makes it possible to prevent a sealing property from deteriorating.

According to the first aspect of the invention, there can be provided play that allows the connection member to move downward such that when the stem falls for valve closing, the lower end surface of the connection member is brought into contact with the bottom surface of the upper end recess in the diaphragm piece.

According to the second aspect of the invention, the connection member has the arc-shaped curved surfaces respectively formed on its upper end surface and lower end surface, and the arc-shaped curved surfaces on the upper end surface and the lower end surface are respectively brought into contact with the bottom surfaces of the lower end recess and the upper end recess by downward movement of the stem for valve closing.

Thus, during valve closing, the upper end surface of the connection member reliably axially contacts the bottom surface of the recess in the stem, and the lower end surface of the connection member reliably axially contacts the bottom surface of the recess in the diaphragm piece, so that an axial force by downward movement of the stem can be transmitted to the bottom surface of the recess in the diaphragm piece without being influenced by an inclination of the diaphragm piece. As a result, the holder is aligned, so that the seal member can be brought into contact with the valve seat surface in an aligned state.

According to the third aspect of the invention, the connection member has the connection through hole formed therein in a direction substantially perpendicular to its axial direction, and is connected to the diaphragm piece via the connection pin inserted into this connection through hole and is connected to the stem via the locked step part locked to the locking step part provided in the recess in the stem, and the locking step part in the stem is brought into contact with the locked step part in the connection member and the inner edge surface of the lower hole of the connection through hole is brought into contact with the connection pin by upward movement of the stem for valve opening.

Thus, the connection member is pulled upward to move upward with the locked step part locked to the locking step part in the stem by upward movement of the stem during valve opening, and the diaphragm piece connected to the connection member that moves upward via the connection pin moves upward so that the holder rises.

Therefore, the holder can be reliably raised to a valve opening position during valve opening.

According to the fourth aspect of the invention, the spacer is arranged on the bottom surface of the upper end recess in the diaphragm piece, and the arc-shaped curved surface on the lower end surface of the connection member is brought into contact with the spacer by downward movement of the stem for valve closing.

This makes it possible to easily adjust a condition of alignment of the holder by adjusting the shape, material, hardness, surface state, thickness, number, or the like.

According to the fifth aspect of the invention, the seal member is composed of polyimide resin, thereby making it possible to prevent the seal member from being damaged due to a high temperature even under a use environment of 300 degrees or more and moreover making it possible to maintain a sealing performance by an alignment function of the pulling-up/aligning mechanism.

According to the sixth aspect of the invention, the seal member is annular, and the holder includes the annular housing part that houses the seal member.

The high-temperature diaphragm valve further includes the seal holding member that includes the cylindrical part having the cylindrical inner surface fitted into the inner peripheral surface of the annular housing part to hold the seal member at a position concentric with the holder, and the annular cushion member that is sandwiched between the respective surfaces, on the bottom surface side of the annular housing part, of the seal holding member and the seal member and the bottom surface and is held in the annular housing part at a position concentric with the holder with its inner peripheral surface fitted into the inner peripheral surface of the annular housing part.

The seal member is held in the annular housing part with the gap formed between the surface facing the bottom surface of the annular housing part and the bottom surface by expanding more radially outward than the annular cushion member.

Thus, with a simple configuration in which there are provided the annular cushion member fitted into the inner peripheral surface of the annular housing part and held at a position concentric with the holder on the bottom surface side of the annular housing part and the gap between the seal member in a region on the outer diameter side of the annular cushion member and the bottom surface of the annular housing part, when the annular cushion member is compressed toward the bottom surface of the annular housing part, the seal member that contacts the valve seat surface, together with the annular cushion member, is deformed for alignment using the gap between seal member and the annular housing part while being compressed toward the bottom surface while effectively exhibiting a cushioning property of the annular cushion member using the gap.

The annular cushion member is positioned on the bottom surface side of the annular housing part, to prevent contact with a control fluid by the seal holding member and seal member. Accordingly, a cushioning property can be prevented from deteriorating due to an influence of a high temperature, and a material having a high cushioning property can be used even if its heat resistance is lower than that of the seal member.

Therefore, it is possible to improve an alignment performance while holding air-tightness with a simple configuration even under a wide range of temperature environments.

According to the seventh aspect of the invention, the annular cushion member is composed of the material having a higher cushioning property than that of the seal member, thereby making it possible to enhance followability of the seal member to the valve seat surface using a cushioning property of the annular cushion member and as a result to enhance air-tightness.

According to the eighth aspect of the invention, the seal holding member includes the flange part protruding in a flange shape radially outward at the end of the cylindrical part, and the seal member has the stepped contact surface, which is brought into contact with the outer peripheral surface of the cylindrical part including the flange part in a stepped shape, formed therein. Accordingly, when the seal member is compressed by contacting the valve seat, even if the seal member axially moves relative to the seal holding member, a control fluid does not enter through a stepped contact portion between the seal holding member and the seal member, thereby making it possible to prevent the control fluid from entering the gap between the seal member and the bottom surface of an annular housing part.

According to the ninth aspect of the invention, the seal member has the recess, in which the annular cushion member is arranged having the peripheral side surface slightly spaced apart from the outer peripheral surface of the annular cushion member, formed on its surface on the bottom surface side of the annular housing part, and the gap is formed between the surface of the seal member radially outside the recess and the bottom surface of the annular housing part, thereby making it possible to set a minimum necessary gap that is enough for the annular cushion member to exhibit a cushioning performance and as a result making it possible to set a minimum necessary gap that allows air-tightness to be enhanced.

According to the tenth aspect of the invention, the seal member is composed of polyimide, and the annular cushion member is composed of perfluoroalkoxyalkane resin. Accordingly, the seal member composed of polyimide resin having a heat resistance of 300 degrees Celsius or more is used for a portion that contacts a control fluid, while the annular cushion member composed of perfluoroalkoxyalkane resin having a heat resistance less than 300 degrees Celsius but having a higher cushioning property than that of polyimide resin is used for a portion that does not contact the control fluid, thereby making it possible to also improve an alignment performance while holding air-tightness with a simple configuration in use under an environment of 300 degrees Celsius or more.

### BRIEF DESCRIPTION OF THE DRAWINGS

FIG. 1 is a cross-sectional view illustrating a schematic configuration a valve opened state of a high-temperature diaphragm valve according to a first embodiment.

FIG. 2 is an enlarged view of the periphery of a connection member in the high-temperature diaphragm valve illustrated in FIG. 1.

FIG. 3 is a cross-sectional view illustrating a schematic configuration of a valve closed state of the high-temperature diaphragm valve according to the first embodiment.

FIG. 4 is an enlarged view of the periphery of a connection member in the high-temperature diaphragm valve illustrated in FIG. 3.

FIG. 5 is a cross-sectional view illustrating a schematic configuration of a valve opened state of a high-temperature diaphragm valve according to a second embodiment.

FIG. 6A is an enlarged view of the periphery of a holder in the high-temperature diaphragm valve illustrated in FIG. 5.

FIG. 6B is an enlarged view illustrating the vicinity of an annular housing part in the holder illustrated in FIG. 6A in a further enlarged manner.

FIG. 7 is a diagram for describing an operation of each member provided in the holder in a valve closing operation of the high-temperature diaphragm valve.

FIG. 8 is a cross-sectional view illustrating a schematic configuration in a conventional technology.

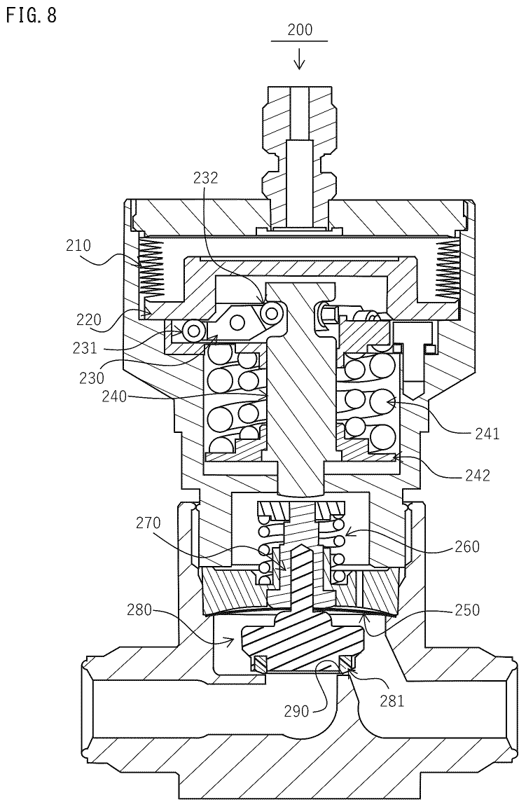

### DETAILED DESCRIPTION OF EMBODIMENTS OF THE INVENTION

Embodiments of a high-temperature diaphragm valve according to the present invention will be specifically described.

The present disclosure is not limited by the embodiments described below. It should be noted that the drawings are schematic and dimensional relationships of elements, ratios of the elements, and the like may be different from actual ones. Further, among the drawings, portions that differ in dimensional relationships and ratios may also be included.

### First Embodiment

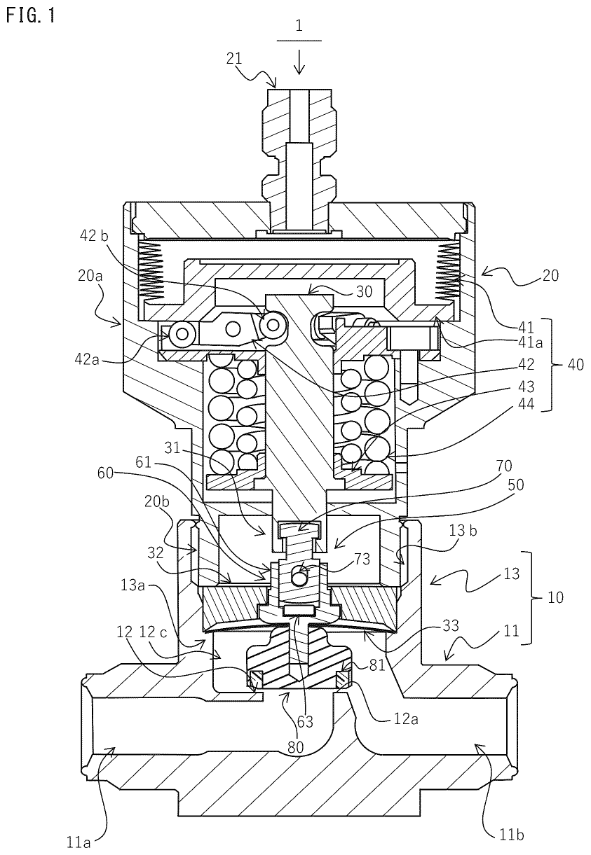

First, a first embodiment will be described with reference to FIGS. 1 to 4.

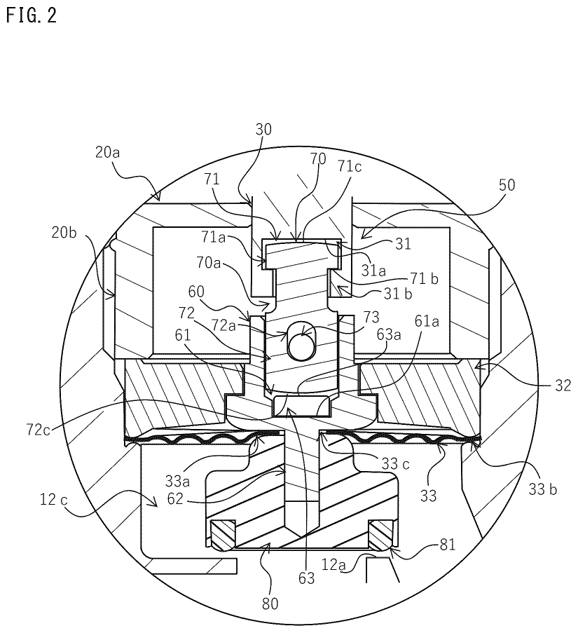

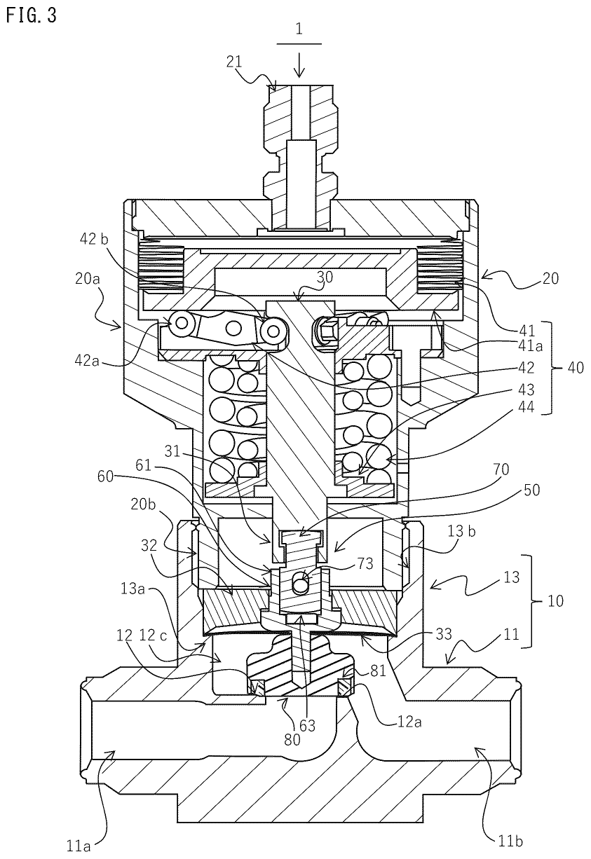

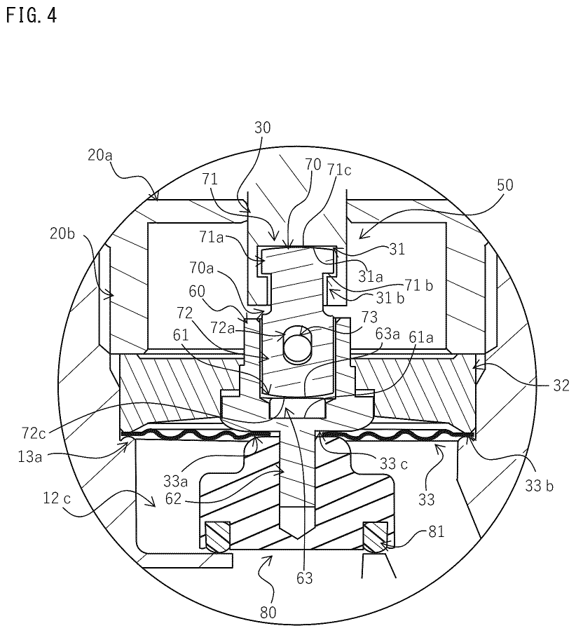

FIG. 1 is a cross-sectional view illustrating a schematic configuration in a valve opened state of a high-temperature diaphragm valve 1 according to the first embodiment. FIG. 2 is an enlarged view of the periphery of a connection member 70 in the high-temperature diaphragm valve 1 illustrated in FIG. 1. FIG. 3 is a cross-sectional view illustrating a schematic configuration in a valve closed state of the high-temperature diaphragm valve 1 according to the first embodiment. FIG. 4 is an enlarged view of the periphery of the connection member 70 in the high-temperature diaphragm valve 1 illustrated in FIG. 3.

The high-temperature diaphragm valve 1 according to the first embodiment is used under a high temperature environment, e.g., under an environment of 300 degrees or more.

The high-temperature diaphragm valve 1 can also be used under an environment other than a high temperature environment. For example, it can be used not only under an ordinary temperature environment but also a low temperature environment.

The high-temperature diaphragm valve 1 moves a holder 80, which is suspended by a diaphragm 33 that hermetically seals a valve chamber 12c and holds a seal member 81 to be brought into contact with a valve seat surface 12a during valve closing, to a valve opening/closing position in conjunction with a stem 30. The high-temperature diaphragm valve 1 includes a body 10 and an actuator 20 assembled onto an upper portion of the body 10.

### <As to Body 10>

The body 10 is composed of a metal material and is integrally provided with a main body 11 having a gas flow path formed therein and a connection part 13 connected to the actuator 20.

In the main body 11, a primary-side flow path 11a on a gas inflow side and a secondary-side flow path 11b on a gas outflow side are provided with a valve seat 12 having the flat valve seat surface 12a, with which the seal member 81 described below is moved into and out of contact, interposed therebetween.

The connection part 13 protrudes in a cylindrical shape from the main body 11 at a position above the valve seat 12 to which the actuator 20 is assembled. This connection part 13 has an annular step part 13a, in which a bonnet 32 is seated with an outer peripheral edge 33b of the diaphragm 33 sandwiched therebetween, and a thread part 13b, which is screwed into a thread part 20b formed on an outer peripheral surface of a lower portion of a case 20a in the actuator 20, formed on its inner peripheral surface.

### <As to Actuator 20>

The actuator 20 moves the stem 30 up and down to the valve opening/closing position. In this actuator 20, a raising/lowering mechanism 40 that moves the stem 30 up and down and a pulling-up/aligning mechanism 50 having a function of pulling up the holder 80 in conjunction with a raising operation of the stem 30 during valve opening and a function of aligning the holder 80 during valve closing are provided in the case 20a.

### <As to Raising/Lowering Mechanism 40 in Actuator 20>

The raising/lowering mechanism 40 includes a bellows 41 composed of a metal material, a plurality of cams 42, and a spring 44.

The bellows 41 receives air introduced from an air introduction coupling 21 therein with a bellows flange 41a disposed at its lower end.

Each of the plurality of cams 42 is pivotably attached to an inner wall of the case 20a with rollers 42a and 42b provided at both its ends.

The spring 44 adds a force to move the stem 30 to a valve closing position located therebelow via a retainer 43.

In the cam 42, the roller 42a on one end side is arranged to be contactable at an outer peripheral edge of the bellows flange 41a, and the roller 42b on the other end side is arranged in a groove formed in an annular shape on an outer peripheral surface of an upper portion of the stem 30. A plurality of such cams 42 are arranged in a dispersed manner around an outer periphery of the stem 30.

### <As to Pulling-Up/Aligning Mechanism 50 in Actuator 20>

The pulling-up/aligning mechanism 50 includes a diaphragm piece 60 and the connection member 70.

This pulling-up/aligning mechanism 50 has a lower end recess 31, which is provided at a lower end of the stem 30, included in its configuration.

### <As to Diaphragm Piece 60 in Pulling-Up/Aligning Mechanism 50>

The diaphragm piece 60 is connected to the holder 80 and is held movably up and down by the bonnet 32, and sandwiches an inner peripheral edge 33a of the diaphragm 33, the outer peripheral edge 33b of which is sandwiched between the bonnet 32 and the body 10, between the diaphragm piece 60 and the holder 80.

This diaphragm piece 60 has a bottomed cylindrical shape, forming an upper end recess 61 having an opened upper end at which a lower end of the connection member 70 is arranged in a loosely fitted state.

Although the wave-shaped diaphragm 33 is used in the present embodiment, the shape of the diaphragm is not limited to this, but a dome-shaped diaphragm, for example, may be used.

In the present embodiment, a spacer 63 is arranged on a bottom surface 61a of the upper end recess 61 in the diaphragm piece 60, and an upper surface 63a of the spacer 63 forms the bottom surface 61a of the upper end recess 61.

Therefore, by adjusting the shape, material, hardness, surface state, thickness, or number of spacers 63, for example, a state of the bottom surface of the upper end recess 61 brought into contact with the connection member 70 can be appropriately adjusted.

By forming the upper surface 63a of the spacer 63 into a flat surface or adjusting its surface roughness, for example, a planar state of the bottom surface of the upper end recess 61 can be adjusted to a state suitable for alignment.

The material of the spacer 63 can be adjusted to a state suitable for alignment by being made different from that of the connection member 70 and being made difficult to bite by the connection member 70.

By adjusting the thickness or number of spacers 63, a contact state between the connection member 70 and the bottom surface 61a of the upper end recess 61 with the spacer 63 interposed therebetween can be adjusted to a state suitable for alignment.

On the other hand, a male thread part 62 screwed into the holder 80 through a through hole 33c formed at the center of the diaphragm 33 is provided at a lower end of the diaphragm piece 60. The inner peripheral edge 33a of the diaphragm 33 is sandwiched between the bottom surface of the diaphragm piece 60 around a base end of the male thread part 62 and an upper end surface of the holder 80.

The annular seal member 81 is held at a lower end of the holder 80 connected to this diaphragm piece 60.

The seal member 81 is composed of polyimide resin that can withstand use under a high temperature environment of 300 degrees or more in the present embodiment.

Another material may be used for the seal member 81 if it can withstand use under a high temperature environment of 300 degrees or more. For example, a seal member composed of a metal material may be used.

A connection structure between the diaphragm piece 60 and the holder 80 is not limited to the above-described one by screwing. That is, another connection structure may be used if it can connect the diaphragm piece 60 and the holder 80 to each other with the inner peripheral edge of the diaphragm 33, the outer peripheral edge of which is sandwiched between the bonnet 32 and the body 10, sandwiched between the diaphragm piece 60 and the holder 80. For example, the diaphragm piece 60 and the holder 80 may be fastened to each other with the diaphragm 33 sandwiched therebetween.

### <As to Connection Member 70 in Pulling-Up/Aligning Mechanism 50>

The connection member 70 has an outer contour having a substantially columnar shape, and has a connection through hole 72a formed therein in a direction substantially perpendicular to its axial direction. The connection member 70 is connected to the diaphragm piece 60 via the connection pin 73 inserted into this connection through hole 72a, and is connected to the stem 30 via a locked step part 71a locked to a locking step part 31b provided in the lower end recess 31 in the stem 30.

This connection member 70 has an annular recess 70a formed on its outer peripheral surface, whereby a head part 71 is formed in its upper portion and a columnar trunk part 72 is formed in its lower portion below the annular recess 70a.

The head part 71 has its lower surface formed into a locked surface 71b of the locked step part 71a locked to the locking step part 31b provided in the lower end recess 31 in the stem 30, and is arranged in a loosely fitted state in the lower end recess 31 in the stem 30.

The trunk part 72 has the above-described connection through hole 72a formed therein, and is arranged in a loosely fitted state in the upper end recess 61 in the diaphragm piece 60 by the connection pin 73 inserted into the connection through hole 72a through a through hole not illustrated formed in the upper end recess 61 in the diaphragm piece 60.

The connection through hole 72a has an elongated hole shape in which a raising/lowering direction of the stem 30 is set as its longitudinal direction. The connection through hole 72a more specifically has a longitudinal dimension set larger than the diameter of the connection pin 73. This provides play that allows the connection member 70 to move downward such that when the stem 30 falls for valve closing, a lower end surface of the connection member 70 is brought into contact with the bottom surface of the upper end recess 61 in the diaphragm piece 60, i.e., the upper surface 63a of the spacer 63.

### <As to Valve Opening/Closing Operation of High-Temperature Diaphragm Valve 1>

A valve opening/closing operation of the high-temperature diaphragm valve 1 will be described below.

First, the valve opening operation of the high-temperature diaphragm valve 1 will be described.

When the high-temperature diaphragm valve 1 changes from the valve closed state (see FIG. 3) to a valve opened state, air is supplied into the bellows 41 through the air introduction coupling 21. When air is supplied into the bellows 41, the bellows 41 expands so that a lower surface of the bellows flange 41a provided in a lower portion of the bellows 41 and the roller 42a on one end side of the cam 42 contact each other.

Then, the cam 42 rotates to incline the other end side thereof upward, and the roller 42b on the other end side lifts the stem 30 so that the stem 30 rises.

When the stem 30 rises, the locking step part 31b in the lower end recess 31 in the stem 30 contacts the locked surface 71b of the connection member 70 so that the connection member 70 is pulled up. When the connection member 70 is pulled up, an inner edge surface of a lower hole of the connection through hole 72a in the connection member 70 contacts the connection pin 73 to lift the diaphragm piece 60 so that the diaphragm piece 60 rises.

When the diaphragm piece 60 rises, the holder 80 connected to the diaphragm piece 60 rises, resulting in a valve opened state where the seal member 81 separates from the valve seat surface 12a.

At this time, the diaphragm 33 is elastically restored to a state where the periphery of the inner peripheral edge 33a sandwiched between the diaphragm piece 60 and the holder 80 is pulled upward to bulge.

Then, the valve closing operation of the high-temperature diaphragm valve 1 will be described.

When the high-temperature diaphragm valve 1 changes from the above-described valve opened state (see FIG. 1) to a valve closed state, supply of air into the bellows 41 through the air introduction coupling 21 is stopped. When the supply of air into the bellows 41 is stopped, the retainer 43 is pushed down with an elastic force of the spring 44, and the stem 30 locked to the retainer 43 falls.

When the stem 30 falls, a bottom surface 31a of the lower end recess 31 in the stem 30 contacts an arc-shaped curved surface 71c of an upper end surface of the connection member 70 so that the connection member 70 is pushed down. When the connection member 70 is pushed down, an arc-shaped curved surface 72c of the lower end surface of the connection member 70 contacts the upper surface 63a of the spacer 63 so that the diaphragm piece 60 is pushed down.

The diaphragm piece 60 is thus pushed down, whereby the holder 80 connected to the diaphragm piece 60 falls, resulting in a valve closed state where the seal member 81 contacts the valve seat surface 12a.

When the holder 80 thus falls, the connection member 70 contacts both the respective bottom surfaces 31a and 61a of the lower end recess 31 in the stem 30 and the upper end recess 61 in the diaphragm piece 60 to transmit an axial force of the stem 30 to the diaphragm piece 60 by downward movement of the stem 30.

This is because the connection member 70 is arranged in a loosely fitted state in each of the lower end recess 31 in the stem 30 and the upper end recess 61 in the diaphragm piece 60 and the bottom surface 31a of the lower end recess 31 in the stem 30 contacts the upper end surface 71c forming the arc-shaped curved surface of the connection member 70 regardless of a posture of the diaphragm piece 60 and is because the bottom surface 61a of the upper end recess 61 in the diaphragm piece 60, more specifically, the upper surface 63a of the spacer 63 contacts the lower end surface 72c forming the arc-shaped curved surface of the connection member 70.

Therefore, even when the diaphragm piece 60 is inclined with respect to an axis of the stem 30 by rattling between the diaphragm piece 60 and the bonnet 32 so that the holder 80 connected to the diaphragm piece 60 is inclined, the diaphragm piece 60 is aligned and the holder 80 is aligned, whereby the seal member 81 is aligned to contact the valve seat surface 12a.

### <Effect of First Embodiment>

As described above, the high-temperature diaphragm valve 1 according to the embodiment includes the pulling-up/aligning mechanism 50 that connects the stem 30 and the holder 80 to each other.

Thus, even when an elastic restoring force of the diaphragm 33 decreases by use under a high temperature environment, and even if the holder 80 is susceptible to rattling due to being suspended by the diaphragm 33, the pulling-up/aligning mechanism 50 forcibly pulls up the holder 80 during valve opening. During valve closing, the seal member 81 held in the holder 80 seals the valve seat surface 12a with a uniform force.

This makes it possible to stably perform a valve opening/closing operation even under a high temperature environment and makes it possible to prevent a sealing property from deteriorating.

Moreover, with the high-temperature diaphragm valve 1 according to the embodiment, the holder 80 is aligned by the pulling-up/aligning mechanism 50, and the seal member 81 contacts and seals the valve seat surface 12a in an aligned state. Therefore, in the high-temperature diaphragm valve 1 according to the embodiment, it is possible to enhance a sealing property.

In the high-temperature diaphragm valve 1 according to the embodiment, it is possible to reduce a thrust force of the actuator for valve closing and it is possible to make an apparatus compact by reducing a spring as a source of the thrust force to make the actuator compact.

With the high-temperature diaphragm valve 1 according to the embodiment, the pulling-up/aligning mechanism 50 includes the diaphragm piece 60 that sandwiches the inner peripheral edge of the diaphragm 33, the outer peripheral edge 33b of which is sandwiched between the bonnet 32 and the body 10, between the diaphragm piece 60 and the holder 80 and the connection member 70 that is arranged in a loosely fitted state between the lower end recess 31 provided in the stem 30 and the upper end recess 61 provided in the diaphragm piece 60 and to connect the stem 30 and the diaphragm piece 60 to each other and contacts both the respective bottom surfaces 31a and 61a of the lower end recess 31 and the upper end recess 61 to transmit an axial force of the stem 30 to the diaphragm piece 60 by downward movement of the stem 30 for valve closing.

Thus, even when an elastic restoring force of the diaphragm 33 decreases by use under a high temperature environment, the diaphragm piece 60 connected to the stem 30 via the connection member 70 moves upward in conjunction with upward movement of the stem 30 for valve opening. The holder 80 connected to the diaphragm piece 60 can be reliably moved upward to a valve opening position where the seal member 81 separates from the valve seat surface 12a.

During valve closing, even when rattling occurs between the diaphragm piece 60 and the bonnet 32, an axial force of the stem 30 by downward movement of the stem 30 via the connection member 70 is transmitted to the holder 80 through the bottom surface 61a of the upper end recess 61 in the diaphragm piece 60, so that the holder 80 is aligned. The holder 80 is aligned, whereby the seal member 81 is brought into contact with the valve seat surface 12a in an aligned state.

This makes it possible to stably perform a valve opening/closing operation even under a high temperature environment and makes it possible to prevent a sealing property from deteriorating.

With the high-temperature diaphragm valve 1 according to the embodiment, the connection member 70 has the arc-shaped curved surfaces respectively formed on the upper end surface 71c and the lower end surface 72c, and the arc-shaped curved Surfaces of the upper end surface 71c and the lower end surface 72c are respectively brought into contact with both the bottom surfaces 31a and 61a of the lower end recess 31 in the stem 30 and the upper end recess 61 in the diaphragm piece 60 by downward movement of the stem 30 for valve closing.

Thus, during valve closing, the upper end surface 71c of the connection member 70 reliably axially contacts the bottom surface 31a of the lower end recess 31 in the stem 30, and the lower end surface 72c of the connection member 70 reliably axially contacts the bottom surface of the upper end recess 61 in the diaphragm piece 60, more specifically, the upper surface 63a of the spacer 63.

Therefore, an axial force by downward movement of the stem 30 can be transmitted to the bottom surface 61a of the upper end recess 61 in the diaphragm piece 60 without being influenced by an inclination of the diaphragm piece 60. As a result, the holder 80 is aligned, so that the seal member 81 can be brought into contact with the valve seat surface 12a in an aligned state.

With the high-temperature diaphragm valve 1 according to the embodiment, the connection member 70 has the connection through hole 72a formed therein in a direction substantially perpendicular to its axial direction, and is connected to the diaphragm piece 60 via the connection pin 73 inserted into this connection through hole 72a and is connected to the stem 30 via the locked step part 71a locked to the locking step part 31b provided in the lower end recess 31 in the stem 30, and the locking step part 31b in the stem 30 is brought into contact with the locked surface 71b of the locked step part 71a in the connection member 70 and the inner edge surface of the lower hole of the connection through hole 72a is brought into contact with the connection pin 73 by upward movement of the stem 30 for valve opening.

Thus, the connection member 70 is pulled upward to move upward with the locked step part 71a locked to the locking step part 31b in the stem 30 by upward movement of the stem 30 during valve opening. The diaphragm piece 60 connected to the stem 30 that moves upward via the connection pin 73 moves upward so that the holder 80 rises.

Therefore, the holder 80 can be reliably raised to a valve opening position during valve opening.

With the high-temperature diaphragm valve 1 according to the embodiment, the spacer 63 is arranged on the bottom surface 61a of the upper end recess 61 in the diaphragm piece 60, and the arc-shaped curved surface on the lower end surface 72c of the connection member 70 is brought into contact with the upper surface 63a of the spacer 63 by downward movement of the stem 30 for valve closing.

This makes it possible to easily adjust a condition of alignment of the holder 80 by adjusting the shape, material, hardness, surface state, thickness, number, or the like of spacers 63.

With the high-temperature diaphragm valve 1 according to the embodiment, the seal member 81 is composed of polyimide resin, thereby making it possible to prevent the seal member 81 from being damaged due to a high temperature even under a use environment of 300 degrees or more and moreover making it possible to maintain a sealing performance by an alignment function of the pulling-up/aligning mechanism 50.

### Second Embodiment

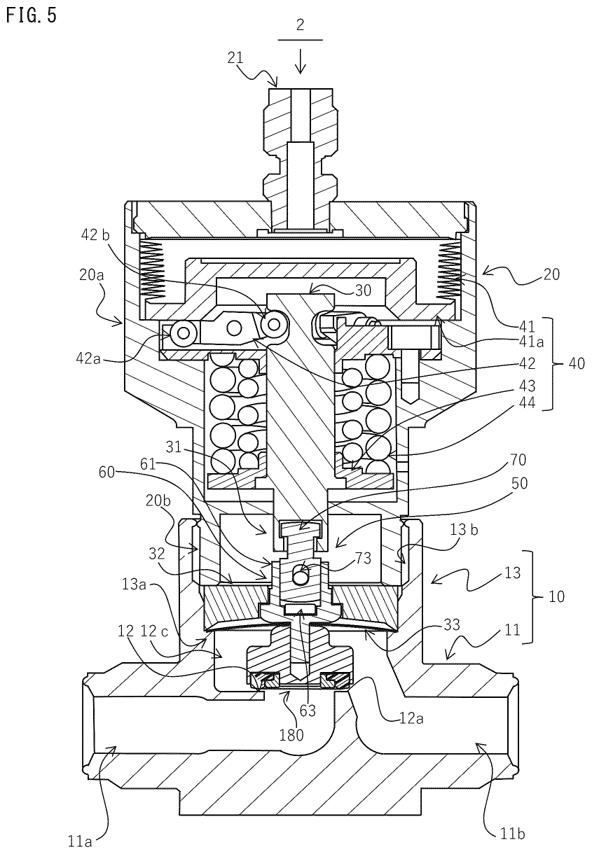

Then, a second embodiment will be described with reference to FIGS. 5 to 7.

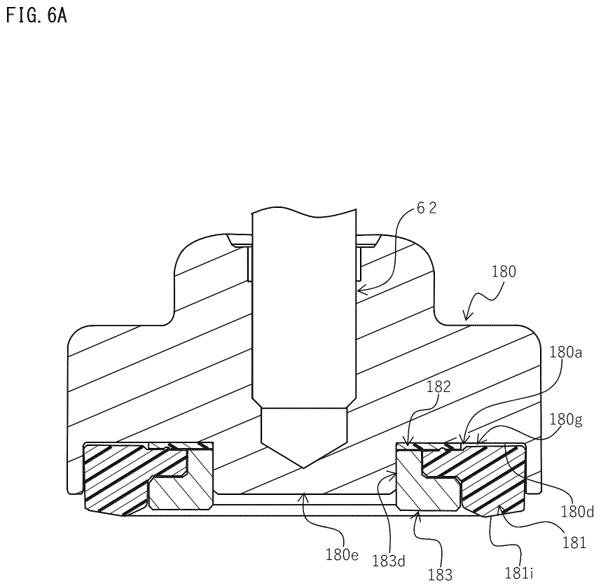

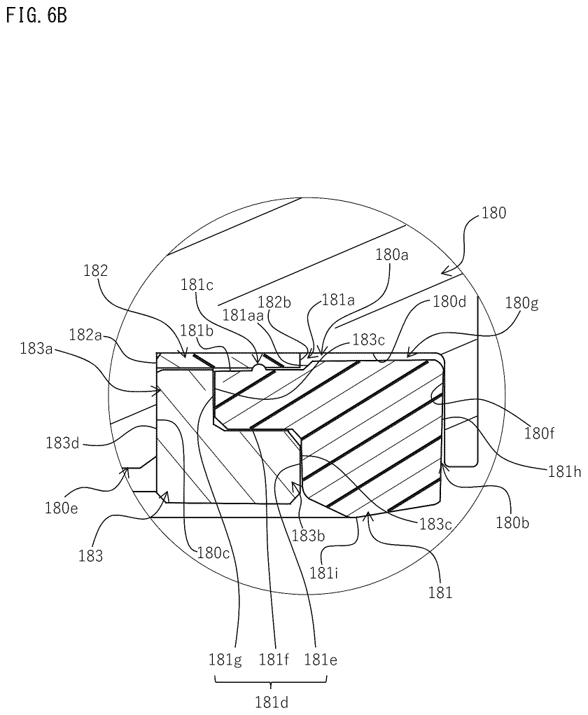

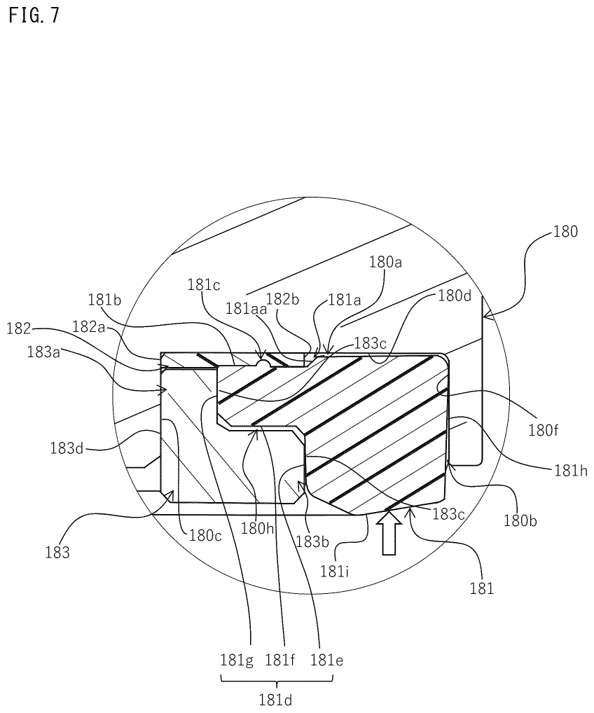

FIG. 5 is a cross-sectional view illustrating a schematic configuration in a valve opened state of a high-temperature diaphragm valve 2 according to the second embodiment. FIG. 6A is an enlarged view of the periphery of a holder 180 in the high-temperature diaphragm valve 2 illustrated in FIG. 5. FIG. 6B is an enlarged view illustrating the vicinity of an annular housing part 180a in the holder 180 illustrated in FIG. 6A in a further enlarged manner. FIG. 7 is a diagram for describing an operation of each member provided in the holder 180 in a valve closing operation of the high-temperature diaphragm valve 2.

In the second embodiment, the same sites as those in the first embodiment are respectively denoted by the same reference numerals to omit overlapping descriptions.

The high-temperature diaphragm valve 2 according to the second embodiment differs from the high-temperature diaphragm valve 1 according to the first embodiment in terms of respective structures of the holder 180 and members held in the holder 180.

In the high-temperature diaphragm valve 2 according to this embodiment, the holder 180 holds an annular seal member 181 and an annular cushion member 182 in the annular housing part 180a using a seal holding member 183.

### <As to Holder 180>

The holder 180 is composed of, for example, a metal material such as a stainless material, and includes the annular housing part 180a that holds the seal member 181.

The annular housing part 180a has an opening 180b formed therein on the side of a valve seat surface 12a, and has a columnar part 180e forming an inner peripheral surface 180c of the annular housing part 180a provided at its center.

This columnar part 180e functions as a portion where the seal holding member 183 and the annular cushion member 182 are held in the annular housing part 180a while being located at a position concentric with the holder 180 by an outer peripheral surface as the inner peripheral surface 180c of the annular housing part 180a being fitted into a cylindrical inner surface 183d of the seal holding member 183 and an inner peripheral surface 182a of the annular cushion member 182.

### <As to Seal Member 181>

The seal member 181 is composed of highly heat-resistant polyimide resin and is held in the annular housing part 180a with a gap 180g formed between a surface facing a bottom surface 180d of the annular housing part 180a and the bottom surface 180d by expanding more radially outward than the annular cushion member 182 in this embodiment.

This seal member 181 is held in the annular housing part 180a while being located at a position concentric with the holder 180 using the seal holding member 183, as described above.

The seal member 181 has a recess 181a, in which the annular cushion member 182 is arranged having a peripheral side surface 181aa slightly spaced apart from an outer peripheral surface 182b of the annular cushion member 182, formed on its surface on the bottom surface 180d side of the annular housing part 180a, as illustrated in FIG. 6B.

The gap 180g is formed between a surface of the seal member 181 radially outside the recess 181a in the seal member 181 and the bottom surface 180d of the annular housing part 180a.

The width of this gap 180g is adjusted to such an extent that a cushioning property of the annular cushion member 182 can be effectively exhibited and to such an extent that the seal member 181 can be deformed for alignment when the seal member 181 is compressed by contacting the valve seat surface 12a in order for the holder 180 to move to a valve closing position.

An annular protrusion 181c, which is crimped onto a surface of the annular cushion member 182, is provided on a bottom surface 181b of the recess 181a.

This annular protrusion 181c is a portion that increases a degree of adhesion between the seal member 181 and the annular cushion member 182 in a region radially inside a region where the gap 180g is formed in order to block an entry path of a control fluid into the above-described gap 180g.

The seal member 181 has a stepped contact surface 181d, which is brought into contact with an outer peripheral surface 183c of a cylindrical part 183a including a flange part 183b described below in the seal holding member 183 in a stepped shape, formed therein, as illustrated in FIG. 6B.

The stepped contact surface 181d includes a first contact surface 181e brought into contact with the outer peripheral surface 183c of the flange part 183b, a second contact surface 181f brought into contact with a surface of the flange part 183b facing the bottom surface 180d of the annular housing part 180a, and a third contact surface 181g brought into contact with an outer peripheral surface of an end, on the bottom surface 180d side of the annular housing part 180a, of the seal holding member 183.

The first contact surface 181e and the third contact surface 181g are each an inner peripheral surface of the seal member 181 described as a surface brought into contact with the outer peripheral surface 183c of the seal holding member 183 when the seal member 181 is arranged at a position concentric with the holder 180 by the seal holding member 183.

The seal member 181 is in a state where the three first to third contact surfaces 181e, 181f, and 181g respectively contact corresponding surfaces of the seal holding member 183 when the holder 180 is at a valve opening position, i.e. in an elastically neutral state where the seal member 181 has not been compressed.

An outer peripheral surface 181h of the seal member 181 is provided to be inclined to enlarge its outer diameter from the valve seat surface 12a side toward the bottom surface 181d side of the annular housing part 180a.

Thus, the seal member 181 makes the outer peripheral surface 181h of the seal member 181 adhere to an outer peripheral surface 180f of the annular housing part 180a in the vicinity of the bottom surface 180d of the annular housing part 180a while keeping a contact area with the annular housing part 180a small.

Therefore, a control fluid is reliably prevented from entering the gap 180g by passing between the outer peripheral surface 181h of the seal member 181 and the outer peripheral surface 180f of the annular housing part 180a.

### <As to Seal Holding Member 183>

The seal holding member 183 is composed of, for example, a metal material such as a stainless material, and includes the cylindrical part 183a, the cylindrical inner surface 183d of which is fitted into the inner peripheral surface 180c of the annular housing part 180a, to hold the seal member 181 at a position concentric with the holder 180.

The seal holding member 183 has the flange part 183b protruding in a flange shape radially outward at an end of the cylindrical part 183a, and is brought into contact with the stepped contact surface 181d of the seal member 181.

The seal member 181 is held in the annular housing part 180a at a position concentric with the holder 180 by fitting the inner peripheral surfaces 181e and 181g into the outer peripheral surface 183c of the cylindrical part 183a.

The seal holding member 183 does not contact the valve seat surface 12a by being adjusted such that its surface on the valve seat surface 12a side is at a lower position than a valve seat contact surface 181i of the seal member 181 on the same side.

### <As to Annular Cushion Member 182>

The annular cushion member 182 is a annular seat member having a cushioning property, and is composed of perfluoroalkoxyalkane resin in this embodiment. That is, in this embodiment, a material having a higher cushioning property than that of the seal member 181 is used as the annular cushion members 182.

In the present embodiment, a cushioning property is a property including followability by which an object is deformed by flexibly following another object in contact therewith and elasticity by which the object is restored from a compressed and deformed state.

A high cushioning property means that an object has high followability while having elasticity by which the object is restored from a compressed and deformed state.

The annular cushion member 182 is sandwiched between respective surfaces, on the bottom surface 180d side of the annular housing part 180a, of the seal holding member 183 and the seal member 181 and the bottom surface 180d of the annular housing part 180a and is held in the annular housing part 180a at a position concentric with the holder 180 with the inner peripheral surface 182a fitted into the inner peripheral surface 180c of the annular housing part 180a.

An example of the annular cushion member 182 to be used may be one having substantially the same cushioning property as that of the seal member 181 if it has a cushioning property. The reason for this is that the annular cushion member 182 is arranged at a position where it does not directly contact a high-temperature control fluid, thereby making it possible to prevent the cushioning property from deteriorating even under a wide range of temperature environments also including a high temperature environment.

### <As to Operation of Each Member Provided in Holder 180 in Valve Opening/Closing Operation of High-Temperature Diaphragm Valve 2>

In a valve opening operation of the above-described high-temperature diaphragm valve 2, when there occurs a valve opened state where the holder 180 rises and the seal member 181 separates from the valve seat surface 12a, the seal member 181 that has been compressed by contacting the valve seat surface 12a and the annular cushion member 182 that has been compressed via the seal member 181 are elastically restored.

On the other hand, in a valve closing operation of the high-temperature diaphragm valve 2, even when a diaphragm piece 60 is inclined with respect to an axis of a stem 30 due to rattling between the diaphragm piece 60 and a bonnet 32 so that the holder 180 connected to the diaphragm piece 60 is inclined, the seal member 181 is brought into contact with the valve seat surface 12a with the diaphragm piece 60 aligned and the holder 180 aligned by a pulling-up/aligning mechanism 50.

After the seal member 181 thus contacts the valve seat surface 12a, when the holder 180 further falls in conjunction with the stem 30, the seal member 181 is compressed by a reaction force received from the valve seat surface 12a and the annular cushion member 182, which overlaps the seal member 181 on the bottom surface 180d side of the annular housing part 180a, is compressed, as illustrated in FIG. 7.

The annular cushion member 182 is elastically compressed and deformed while flexibly following the seal member 181 when it is pressed against the seal member 181. Therefore, the annular cushion member 182 is compressed and deformed while adhering to the seal member 181 without a gap occurring between the annular cushion member 182 and the seal member 181 and while being pressed against the bottom surface 180d of the annular housing part 180a.

Therefore, the seal member 181 that contacts the valve seat surface 12a is deformed to follow the valve seat surface 12a by further adding a cushioning property of the annular cushion member 182 to a cushioning property of the seal member 181 itself to enhance a cushioning performance.

The above-described gap 180g is provided, thereby making it possible to effectively use the cushioning property of the annular cushion member 182 until the seal member 181 is brought into contact with the bottom surface 180d of the annular housing part 180a while being compressed by contacting the valve seat surface 12a.

The seal member 181 is deformed to align the holder 180 using the gap 180g.

That is, in this embodiment, an alignment function of the pulling-up/aligning mechanism 50 and an alignment function on the holder 180 side are combined to further enhance an alignment performance.

When the seal member 181 and the annular cushion member 182 are compressed by a reaction force received from the valve seat surface 12a by the seal member 181, a gap 180h occurs between the seal member 181 and the seal holding member 183, as illustrated in FIG. 7.

While the gap 180h thus occurs, the stepped contact surface 181d, other than a surface where the gap 180h is formed, of the seal member 181 swells toward a corresponding surface of the seal holding member 183, to further adhere to a corresponding surface of the seal holding member 183, thereby making it possible to prevent a control fluid from entering the gap 180h.

### <Effect of Second Embodiment>

With the high-temperature diaphragm valve 2 according to this embodiment, the holder 180 includes the annular housing part 180a that houses the seal member 181. The high-temperature diaphragm valve 2 includes the seal holding member 183 that includes the cylindrical part 183a having the cylindrical inner surface 183d fitted into the inner peripheral surface 180c of the annular housing part 180a to hold the seal member 181 at a position concentric with the holder 180, and the annular cushion member 182 that is sandwiched between the respective surfaces, on the bottom surface 180d side of the annular housing part 180a, of the seal holding member 183 and the seal member 181 and the bottom surface 180d and is held in the annular housing part 180a at a position concentric with the holder 180 with the inner peripheral surface 182a fitted into the inner peripheral surface 180c of the annular housing part 180a. The seal member 181 is held in the annular housing part 180a with the gap 180g formed between the surface facing the bottom surface 180d of the annular housing part 180a and the bottom surface 180d by expanding more radially outward than the annular cushion member 182.

This results in a simple configuration in which there are provided the annular cushion member 182 fitted into the inner peripheral surface 180c of the annular housing part 180a and held at a position concentric with the holder 180 on the bottom surface 180d side of the annular housing part 180a and the gap 180g between the seal member 181 in a region on the outer diameter side of the annular cushion member 182 and the bottom surface 180d of the annular housing part 180a.

With this simple configuration, when the annular cushion member 182 is compressed toward the bottom surface 180d of the annular housing part 180a, the seal member 181 that contacts the valve seat surface 12a, together with the annular cushion member 182, is deformed for alignment using the gap 180g while being compressed toward the bottom surface 180d while effectively exhibiting a cushioning property of the annular cushion member 182 using the gap 180g.

The annular cushion member 182 is positioned on the bottom surface 180d side of the annular housing part 180a, to prevent contact with a control fluid by the seal holding member 183 and seal member 181. Accordingly, a cushioning property can be prevented from deteriorating due to an influence of a high temperature, and a material having a high cushioning property can be used even if its heat resistance is lower than that of the seal member 181.

Therefore, with the high-temperature diaphragm valve 2 according to this embodiment, it is possible to improve an alignment performance while holding air-tightness with a simple configuration even under a wide range of temperature environments also including a high temperature environment.

With the high-temperature diaphragm valve 2 according to this embodiment, the holder 180 is aligned by being also made to have an alignment function in addition to the pulling-up/aligning mechanism 50, thereby making it possible to improve an alignment performance and particularly making it possible to also improve an alignment performance for a valve of a large size that is difficult to align.

With the high-temperature diaphragm valve 2 according to the embodiment, the annular cushion member 182 is composed of the material having a higher cushioning property than that of the seal member 181, thereby making it possible to enhance followability of the seal member 181 to the valve seat surface 12a using a cushioning property of the annular cushion member 182 and as a result to enhance air-tightness.

With the high-temperature diaphragm valve 2 according to the embodiment, the seal holding member 183 includes the flange part 183b protruding in a flange shape radially outward at the end of the cylindrical part 183a, and the seal member 181 has the stepped contact surface 181d, which is brought into contact with the outer peripheral surface 183c of the cylindrical part 183a including the flange part 183b in a stepped shape, formed therein. Accordingly, when the seal member 181 is compressed by contacting a valve seat 12, even if the seal member 181 axially moves relative to the seal holding member 183, a control fluid does not enter through a stepped contact portion between the seal holding member 183 and the seal member 181, thereby making it possible to prevent a control fluid from entering the gap 180g between the seal member 181 and the bottom surface 180d of the annular housing part 180a.

With the high-temperature diaphragm valve 2 according to the embodiment, the seal member 181 has the recess 181a, in which the annular cushion member 182 is arranged having the peripheral side surface 181aa slightly spaced apart from the outer peripheral surface 182b of the annular cushion member 182, formed therein on its surface on the bottom surface 180d side of the annular housing part 180a, and the gap 180g is formed between the surface of the seal member 181 radially outside the recess 181a and the bottom surface 180d of the annular housing part 180a, thereby making it possible to set a minimum necessary gap 180g that is enough for the annular cushion member 182 to exhibit a cushioning performance and as a result making it possible to set a minimum necessary gap 180g that allows air-tightness to be enhanced.

With the high-temperature diaphragm valve 2 according to the embodiment, the seal member 181 is composed of polyimide, and the annular cushion member 182 is composed of perfluoroalkoxyalkane resin. Accordingly, the seal member 181 composed of polyimide resin having a heat resistance of 300 degrees Celsius or more is used for a portion that contacts a control fluid, while the annular cushion member 182 composed of perfluoroalkoxyalkane resin having a heat resistance less than 300 degrees Celsius but having a higher cushioning property than that of polyimide resin is used for a portion that does not contact the control fluid, thereby making it possible to also improve an alignment performance while holding air-tightness with a simple configuration in use under an environment of 300 degrees Celsius or more.

Although the embodiments of the preset disclosure have been described above, the present disclosure is not limited to the above-described embodiments, but various modifications may be made without departing from the spirit thereof.

For example, although an example in which the connection member 70 is connected to the diaphragm piece 60 via the connection pin 73 is illustrated in the above-described embodiment, the connection member and the diaphragm piece may not connected to each other using the connection pin. For example, an annular protrusion is provided on an outer peripheral surface of a columnar trunk part in a connection member, and this annular protrusion is arranged in an annular recess provided on an inner peripheral surface of an upper end recess in a diaphragm piece. The annular recess may be set to have a width provided with play that allows the connection member to move downward such that when a stem falls for valve closing, a lower end surface of the connection member is brought into contact with a bottom surface of the recess in the diaphragm piece, i.e., an upper surface of a spacer.

For example, although an example in which the outer peripheral edge 33b of the diaphragm 33 is sandwiched between the bonnet 32 and the body 10 is illustrated in the above-described embodiment, the outer peripheral edge 33b of the diaphragm 33 may be held in the body 10.

For example, although an example in which the spacer 63 is arranged on the bottom surface 61a of the upper end recess 61 in the diaphragm piece 60 so that the upper surface 63a of the spacer 63 contacts the lower end surface 72c of the connection member 70 is illustrated in the above-described embodiment, the spacer 63 may not be arranged in the diaphragm piece 60 so that the bottom surface 61a of the upper end recess 61 contacts the lower end surface 72c of the connection member 70.

For example, although an example in which the seal member 181 is composed of polyimide resin and the annular cushion member 182 is composed of perfluoroalkoxyalkane resin is illustrated in the above-described embodiment, the seal member 181 and the annular cushion member 182 are not limited to these resins but may be made of other materials if the seal member 181 functions as sealing element and the annular cushion member 182 is a member having a cushioning property.

It should be understood that each of the embodiments disclosed herein is illustrative and nonrestrictive in all respects. The above-described embodiments may be omitted, substituted, or changed in various forms without departing from the appended claims and the scope thereof.

### REFERENCE SIGNS LIST

1, 2 high-temperature diaphragm valve
10 body
12a valve seat surface
30 stem
31 lower end recess
31a bottom surface
31b locking step part
33 diaphragm
33a inner peripheral edge
33b outer peripheral edge
50 pulling-up/aligning mechanism
60 diaphragm piece
61 upper end recess
61a bottom surface
63 spacer
70 connection member
71a locked step part
71c arc-shaped curved surface (upper end surface)
72a connection through hole
72c arc-shaped curved surface (lower end surface)
73 connection pin
80, 180 holder
81, 181 seal member
180a annular housing part
180b opening
180c inner peripheral surface
180d bottom surface
180e columnar part
180f outer peripheral surface
180g gap
180h gap
181a recess
181aa peripheral side surface
181b bottom surface
181c annular protrusion
181d stepped contact surface
181e first contact surface
181f second contact surface
181g third contact surface
181h outer peripheral surface
181i valve seat contact surface
182 annular cushion member
182a inner peripheral surface
182b outer peripheral surface
183 seal holding member
183a cylindrical part
183b flange part
183c outer peripheral surface
183d cylindrical inner surface

1. A high-temperature diaphragm valve comprising:
a holder that is suspended by a diaphragm that hermetically seals a valve chamber and moves to a valve opening/closing position in conjunction with a stem with a seal member to be brought into contact with a valve seat surface during valve closing held therein; and
a pulling-up/aligning mechanism that connects the stem and the holder to each other, wherein
the pulling-up/aligning mechanism includes
a diaphragm piece that sandwiches an inner peripheral edge of the diaphragm, an outer peripheral edge of which is held in a body, between the diaphragm piece and the holder, and
a connection member that is arranged in a loosely fitted state between a lower end recess provided in the stem and an upper end recess provided in the diaphragm piece and to connect the stem and the diaphragm piece to each other and contacts both respective bottom surfaces of the lower end recess and the upper end recess to transmit an axial force of the stem to the diaphragm piece by downward movement of the stem for valve closing,
the connection member has an elongated hole-shaped connection through hole, a width in an axial direction of the connection member of which is larger than a diameter of the connection pin, formed therein in a direction substantially perpendicular to the axial direction of the connection member and is connected to the diaphragm piece via the connection pin inserted into the connection diaphragm piece, and
the holder is forcibly pulled up by the pulling-up/aligning mechanism during valve opening, and the seal member held in the holder by the pulling-up/aligning mechanism seals the valve seat surface with a uniform force during valve closing.

2. (canceled)

3. The high-temperature diaphragm valve according to claim 1, wherein
the connection member has arc-shaped curved surfaces respectively formed on its upper end surface and lower end surface, and
the arc-shaped curved surfaces on the upper end surface and the lower end surface are respectively brought into contact with the bottom surfaces of the lower end recess and the upper end recess by downward movement of the stem for valve closing.

4. The high-temperature diaphragm valve according to claim 1, wherein
the connection member is connected to the stem via a locked step part locked to a locking step part provided in the lower end recess, and
the locking step part in the stem is brought into contact with the locked step part in the connection member and an inner edge surface of a lower hole of the connection through hole is brought into contact with the connection pin by upward movement of the stem for valve opening.

5. The high-temperature diaphragm valve according to claim 1, wherein
a spacer is arranged on the bottom surface of the upper end recess, and
the arc-shaped curved surface on the lower end surface is brought into contact with the spacer by downward movement of the stem for valve closing.

6. The high-temperature diaphragm valve according to claim 1, wherein the seal member is composed of polyimide resin.

7. The high-temperature diaphragm valve according to claim 1, wherein
the seal member is annular, and
the holder includes an annular housing part that houses the seal member, and further comprising
a seal holding member that includes a cylindrical part having a cylindrical inner surface fitted into an inner peripheral surface of the annular housing part to hold the seal member at a position concentric with the holder, and
an annular cushion member that is sandwiched between respective surfaces, on a bottom surface side of the annular housing part, of the seal holding member and the seal member and the bottom surface of the annular housing part and is held in the annular housing part at a position concentric with the holder with its inner peripheral surface fitted into the inner peripheral surface of the annular housing part,
the seal member being held in the annular housing part with a gap formed between a surface facing the bottom surface of the annular housing part and the bottom surface of the annular housing part by expanding more radially outward than the annular cushion member.

8. The high-temperature diaphragm valve according to claim 7, wherein the annular cushion member is composed of a material having a higher cushioning property than that of the seal member.

9. The high-temperature diaphragm valve according to claim 7, wherein
the seal holding member includes a flange part protruding in a flange shape radially outward at an end of the cylindrical part, and
the seal member has a stepped contact surface, which is brought into contact with an outer peripheral surface of the cylindrical part including the flange part in a stepped shape, formed therein.

10. The high-temperature diaphragm valve according to claim 7, wherein
the seal member has a recess, in which the annular cushion member is arranged having a peripheral side surface slightly spaced apart from an outer peripheral surface of the annular cushion member, formed on its surface on the bottom surface side of the annular housing part, and
the gap is formed between a surface of the seal member radially outside the recess and the bottom surface of the annular housing part.

11. The high-temperature diaphragm valve according to claim 7, wherein
the seal member is composed of polyimide resin, and
the annular cushion member is composed of perfluoroalkoxyalkane resin.

12. The high-temperature diaphragm valve according to claim 3, wherein
the connection member is connected to the stem via a locked step part locked to a locking step part provided in the lower end recess, and
the locking step part in the stem is brought into contact with the locked step part in the connection member and an inner edge surface of a lower hole of the connection through hole is brought into contact with the connection pin by upward movement of the stem for valve opening.

13. The high-temperature diaphragm valve according to claim 3, wherein
a spacer is arranged on the bottom surface of the upper end recess, and
the arc-shaped curved surface on the lower end surface is brought into contact with the spacer by downward movement of the stem for valve closing.
